(19) United States
(12) Patent Application Publication
(10) Pub. No.: US 2008/0166931 A1
(43) Pub. Date: Jul. 10, 2008

(54) Conducting crimp terminal structure of plug capable of simplifying its manufacturing process

(76) Inventor: Ming-Shan Wang, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/649,769

(22) Filed: Jan. 5, 2007

(51) Int. Cl. H01R 4/10

(52) U.S. Cl. 439/877

(57) ABSTRACT

The present invention discloses a conducting crimp terminal structure of a plug capable of simplifying its manufacturing process, and particularly a flat conducting crimp terminal structure of a solid knife body with a thickness of 1.5 mm that includes a conducting crimp terminal having a flat rectangular body and defining an external section electrically connected to a power supply socket, an internal section connected to an electric wire, a penetrating hole disposed at a flat surface of the internal section and stamped from the flat rectangular body, and a protruding ring perpendicular to a plane; and an electric wire, with a front section of its core disposed in the penetrating hole, and compressed and tied with the protruding ring for electrically connecting the conducting crimp terminal, so as to achieve the effects of simplifying the manufacturing process and reducing the length of the internal section.

### BACKGROUND OF THE INVENTION

1. Field of the Invention

The present invention relates to an improved conducting crimp terminal structure of a plug, and more particularly to a conducting crimp terminal capable of simplifying the manufacturing process and reducing the length of the conducting crimp terminal.

2. Description of the Related Art

To connect a plug with a socket electrically, two or three metal plates or metal rods (which are also known as conducting crimp terminals) in a predetermined shape are built at the front distal surface or a bottom surface of a main body of the plug or socket. There are various different kinds and specifications of the conducting crimp terminals, and the most popular one is a flat conducting crimp terminal 20 with a solid knife body of a thickness of 1.5 mm as shown in FIG. 2.

Referring to FIG. 1 for the manufacturing method of the conventional conducting crimp terminal 20, a metal sheet 11 comes with a thickness t1 equal to 1.5 mm, and an upper-section surface 12 of the metal sheet 11 is milled into a smaller thickness t2 by a milling machine, so that the metal sheet 11 can be bent and folded in a later stamping process. The manufacturing process requires an additional milling process, not only increasing manufacturing time, but also wasting material.

Since the conventional conducting crimp terminal 20 as shown in FIG. 2 requires a knife body 21 and a thinner upper-section surface 12 to be stamped into an U-shaped body 22, and the U-shaped body 22 wraps a core 31 of an electric wire 30 (as shown in FIG. 3), and the U-shaped body comes with specific length and width, therefore an excessively large waste material gap d1 between two adjacent knife bodies 21 is formed and a large quantity of unnecessarily stamped metal materials is incurred. As a result, the cost is increased drastically, particularly when the recent price of copper is very high. Furthermore, the conventional conducting crimp terminal 20 as shown in FIGS. 2 and 3 requires a length L1 of the knife body 21, a length L2 of the U-shaped body 22 and a length L3 of an connecting end of the core 31, and these three lengths L1˜L3 are on the same axis X-X, and thus the whole conducting crimp terminal structure becomes very long and occupies much space, and such factors are unfavorable for the design of a plug.

More importantly, the U-shaped body 22 as shown in FIG. 4 is a curved folding body 221 with both lateral sides mutually pressed by stamping the lateral sides inward, such that the core 31 is wrapped and connected electrically. However, the manufacture of such open-type curved and bent structure for wrapping the core 31 has lower stability and precision. Particularly, the two mutually pressed curved folding bodies 221 cannot seal and wrap the core 31 completely by the mutual pressing, and thus such conventional conducting crimp terminals are generally used for small currents. For the electric connection of large currents, a pipe pressing structure is generally adopted.

In view of the foregoing shortcomings, the present invention provides a conducting crimp structure to overcome the shortcomings of the prior art.

### SUMMARY OF THE INVENTION

It is a primary object of the invention to provide a conducting crimp terminal structure of a plug capable of simplifying its manufacturing process and reducing the length in internal section.

Another objective of the present invention is to provide a conducting crimp terminal structure of a plug capable of simplifying its manufacturing process for avoiding a waste of metal materials and lowering the cost of a plug.

A further objective of the present invention is to provide a conducting crimp terminal structure of a plug capable of simplifying its manufacturing process and having the feature of crimping the core securely, and thus the conducting crimp terminal structure is applicable for electrically connecting a large current and enhancing the safety of using a plug.

In order to achieve the above-mentioned objectives, a conducting crimp terminal structure of a plug in accordance with the invention includes:

a) a conducting crimp terminal having a flat rectangular body and defining an external section electrically connected to a power supply slot, an internal section being connected to an electric wire, a penetrating hole being disposed on a flat surface of the internal section and stamped from the flat rectangular body, a protruding ring being perpendicular to a plane; and

b) an electric wire having a front section of a core disposed in the penetrating hole and electrically connected with the conducting crimp terminal by a compressing and tying the protruding ring.

### BRIEF DESCRIPTION OF THE FIGURES

FIG. 1 is a schematic view of a metal sheet used for manufacturing a conventional conducting crimp terminal;

FIG. 2 is a perspective view of a conventional conducting crimp terminal formed by a stamping process;

FIG. 3 is a conventional conducting crimp terminal crimped with an electric wire;

FIG. 4 is a cross-sectional view of Section 4-4 as depicted in FIG. 3;

FIG. 5 is a perspective view of a conducting crimp terminal of the present invention;

FIG. 6 is a cross-sectional view of a conducting crimp terminal of the present invention;

FIG. 7 is a cross-sectional view of a conducting crimp terminal crimped with an electric wire in accordance with the present invention;

FIG. 8 is a cross-sectional view of Section 8-8 as depicted in FIG. 7;

FIG. 9 is a schematic view of forming a compressed surface in accordance with the present invention;

FIG. 10 is a perspective view of a conducting crimp terminal crimped with an electric wire in accordance with the present invention; and

FIG. 11 is a schematic view of an application of a preferred embodiment of the present invention.

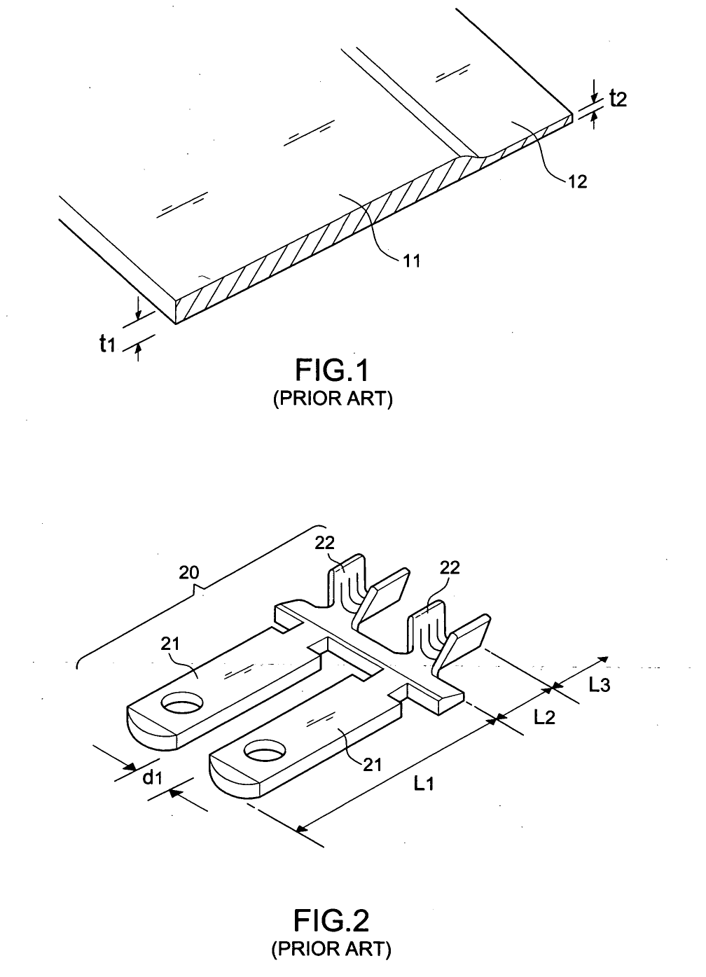

### DETAILED DESCRIPTION OF THE PREFERRED EMBODIMENT

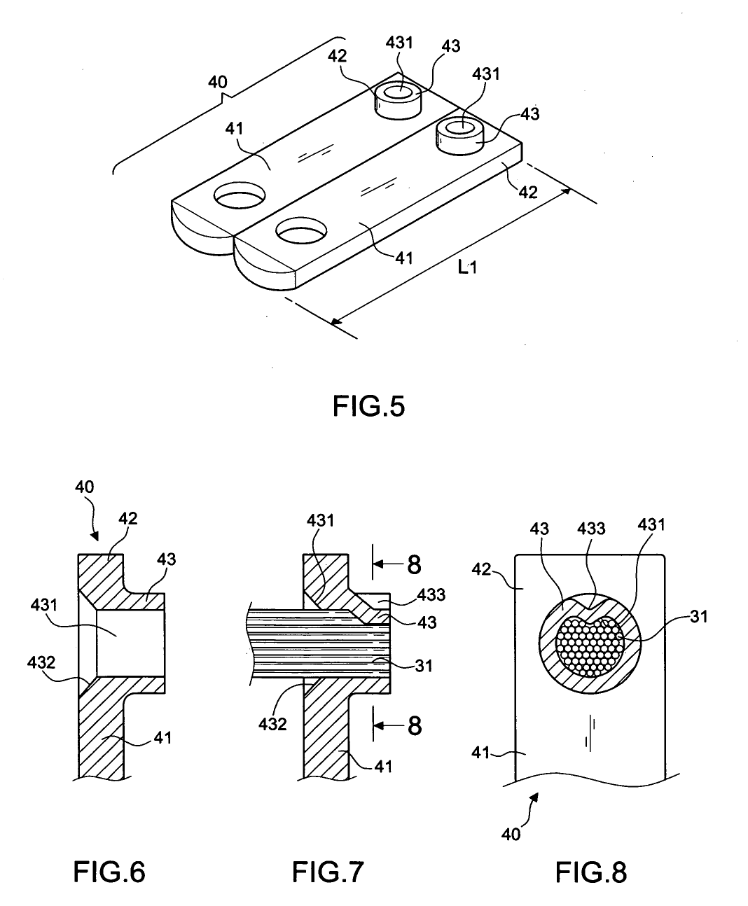

Referring to FIGS. 5 to 8, a preferred embodiment of the present invention comprises the following elements:

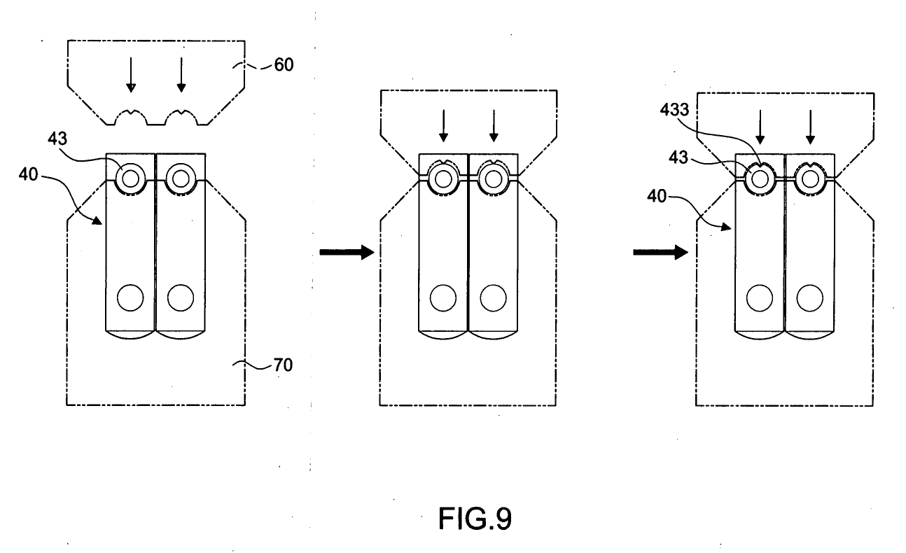

A conducting crimp terminal 40 is integrally formed by stamping a metal sheet of a thickness of 1.5 mm, and the metal sheet are made of a brass sheet or red brass sheet material with good conductivity and malleability, and the key point of the design of the conducting crimp terminal 40 resides on its one-time stamping molding structure without requiring the complicated manufacturing processes such as the milling and secondary bending and folding processes. To achieve the effect, the conducting crimp terminal 40 has a flat rectangular body with a length of L1 and defines an external section 41 for electrically connecting a power supply slot (not shown in the figure), and an internal section 42 connected to an electric wire 30 (as shown in FIG. 9), and the flat surface of the internal section 42 has a penetrating hole 431 integrally stamped from the flat rectangular body and a protruding ring 43 perpendicular to its plane.

Referring to FIG. 6, the internal diameter of the penetrating hole 431 includes an indented surface 432 for facilitating to pass a core 31 of an electric wire 30. After the core 31 has reached a predetermined penetrating hole 431, a tool is used to tie the external periphery of the protruding ring 43 as shown in FIGS. 7 and 8, and a compressed surface 433 is concavely formed on the protruding ring 43 and embedded into the penetrating hole 431. The major difference of this crimp structure with a conventional crimp structure resides on that the conventional crimp structure is formed by an inwardly bent and folded U-shaped body that cannot tie and wrap the core 31 completely, but the protruding ring 43 of the invention is integrally formed with the conducting crimp terminal without any seam to form a compressed surface 433 to tie the core 31 without any seam or gap, so as to secure and tie the core 31 completely. In addition, the conducting crimp structure will not be loosened easily, and both electric connection and conductivity can be enhanced.

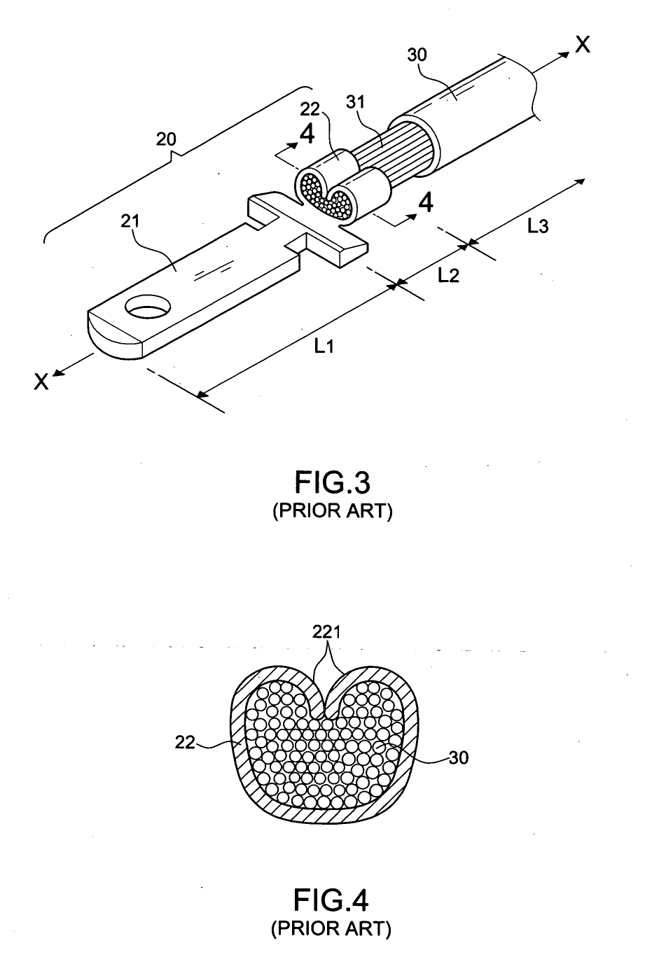

Besides the foregoing characteristics of the secured crimp structure in accordance with the present invention, the invention does not require the width of the conventional U-shaped body, and thus there is no gap between two stamped conducting crimp terminals 40 as shown in FIG. 5. The invention can save a large quantity of unnecessarily stamped metal materials. Furthermore, the length of the conducting crimp terminal 40 is just L1 without involving the length L2 of the conventional U-shaped body 22 as shown in FIG. 3, because such portion is substituted by the protruding ring 43 of the invention. Therefore, the invention can directly lower the cost of the conducting crimp terminal 40 for better economic benefits. As to the formation of the compressed surface 433 of the invention, an upper mold 60 and a lower mold 70 as shown in FIG. 9 can be used for the manufacture of stamping the compressed surface 433 successfully. Such skill is a prior art, and thus will not be described here.

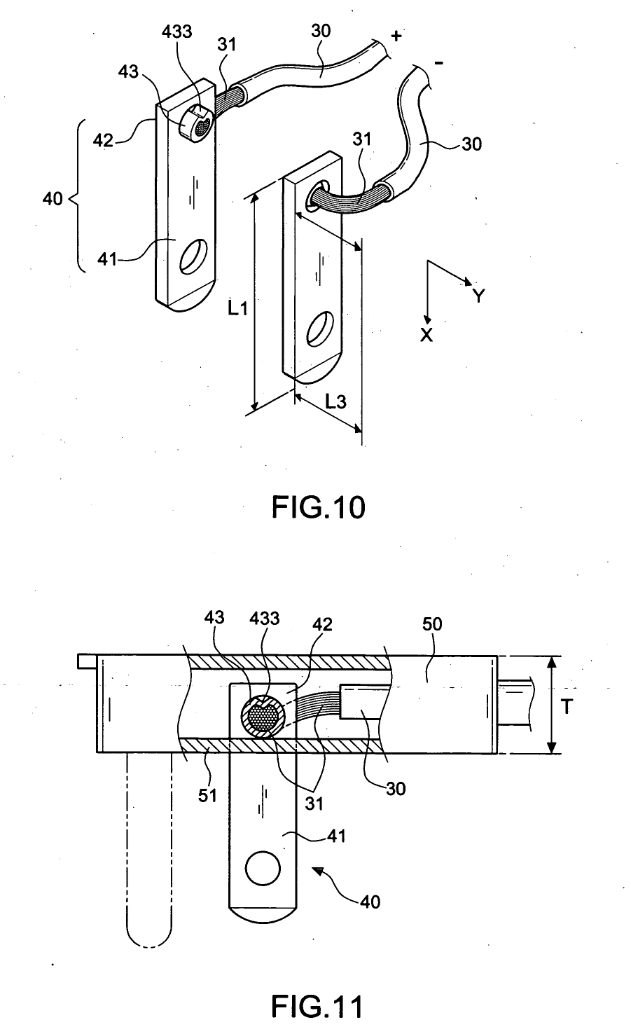

In addition to the foregoing secured structure and the effect of saving materials, the invention also has other characteristics as illustrated in FIG. 10. Unlike the prior art with its electric wire 30 installed at the same axis X-X of the conventional conducting crimp terminal 40, the electric wire 30 of the present invention is installed along the Y axis perpendicular to the X axis, and thus the length L3 of the core 31 is situated at the lateral side of the conducting crimp terminal 40 instead of the upper end of the conducting crimp terminal 40. As a result, such structure comes with a configuration having a set of two opposite symmetric positive and negative conducting crimp terminals, and the structure is suitable for the conducting crimp terminal of a popular flat plug 50 as shown in FIG. 11. The external section 41 of the conducting crimp terminal 40 is perpendicularly extended to the bottom surface of the flat plug 50, and the internal section 42 is fixed into the plug body. Since the protruding ring 43 for connecting the electric wire 30 is integrally formed at a lateral surface of the internal section 42, therefore the thickness T of the flat plug 50 can be very thin and is approximately equal to 10 mm. The present invention does not occupy much space, and thus the thickness of the plug can be decreased significantly. Of course, the structure of the conducting crimp terminal 40 of the invention is not limited to the application for a thin plug only, but it is also applicable for a linear plug. The present invention can achieve the effect of lowering the height of the plug, and thus the invention also can be applied in many other electric connectors.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A conducting crimp terminal structure of a plug capable of simplifying its manufacturing process, and the conducting crimp terminal structure being a flat solid knife body with a thickness of 1.5 mm, comprising:
a) a conducting crimp terminal having a flat rectangular body and defining an external section electrically connected to a power supply slot, an internal section being connected to an electric wire, a penetrating hole being disposed on a flat surface of the internal section and stamped from the flat rectangular body, a protruding ring being perpendicular to a plane; and
b) an electric wire having a front section of a core disposed in the penetrating hole and electrically connected with the conducting crimp terminal by a compressing and tying the protruding ring.

2. The conducting crimp terminal structure of a plug capable of simplifying its manufacturing process as recited in claim 1, wherein the protruding ring has a concavely compressed surface of the penetrating hole.

3. The conducting crimp terminal structure of a plug capable of simplifying its manufacturing process as recited in claim 1, wherein the penetrating hole has a contracted surface disposed within the internal diameter of the penetrating hole.

4. The conducting crimp terminal structure of a plug capable of simplifying its manufacturing process as recited in claim 1, wherein the conducting crimp terminal comes with a configuration having a set of two opposite symmetric positive and negative conducting crimp terminals.

5. The conducting crimp terminal structure of a plug capable of simplifying its manufacturing process as recited in claim 4, wherein the positive and negative conducting crimp terminals have a bottom surface perpendicular to a flat plug.
